(19) United States
(12) Patent Application Publication
(10) Pub. No.: US 2017/0365397 A1
(43) Pub. Date: Dec. 21, 2017

(54) SERVER POWER TRANSFORMER STRUCTURE

(71) Applicant: Compuware Technology Inc., New Taipei City (TW)

(72) Inventors: Wen-Chin Tsai, New Taipei City (TW); Cheng-Chih Liu, New Taipei City (TW); Chien-Ta Liang, New Taipei City (TW)

(21) Appl. No.: 15/183,797

(22) Filed: Jun. 16, 2016

(51) Int. Cl. H01F 27/28

(52) U.S. Cl. CPC H01F 27/2852

(57) ABSTRACT

A server power transformer structure includes: a first iron core, a first projection being configured thereon; an axle body, in combination with the first projection, and configured with four copper foils and first spools, each copper foil, first spool being respectively put around the axle body, at least one first, second, third, fourth connection portion being extended from bottoms of the respective copper foils, and the first spool being sandwiched between each two adjacent copper foils; a second iron core, a second projection being configured thereon, a second spool being put around the second projection, and the second projection being in combination with the axle body; and a solder bar, having a combination portion, first and second through holes, the combination portion being in electric connection with a main board, the connection portions being inserted in and bonded with the respective through holes.

### (a) TECHNICAL FIELD OF THE INVENTION

The present invention relates to a transformer, and more particularly to a high-efficiency server power transformer.

### (b) DESCRIPTION OF THE PRIOR ART

A transformer is a core element indispensable to all power supplies. In response to the current global trends to promote green energy environmental needs, the greater the power density must be and the higher the energy conversion efficiency thereof (for example, 80Plus certification) is required, the more important the designs of main transformers are; transformers must be improved not only to reduce volumes and increase efficiency but to reduce productive time, i.e. to simplify the structure thereof. For transformer manufacturers, the increase in working hours will only make the product have no price advantage, and for power supply vendors, complicated transformers will increase production cost.

### SUMMARY OF THE INVENTION

To overcome the defects mentioned above, the present invention is proposed.

The object of the present invention is to provide a server power transformer structure, having flexibility conforming to half bridge and full bridge structures at the same time, making assembly and manufacturing quick and simple, capable of decreasing productive time effectively.

To achieve the object mentioned above, the present invention is to propose a server power transformer structure, including: a first iron core, a first projection being configured on one end face thereof; an axle body, in combination with the first projection, and configured with at least four copper foils and a plurality of first spools thereon, each the copper foil and each the first spool being respectively put around the axle body, at least one first connection portion, at least one second connection portion, at least one third connection portion and at least one fourth connection portion being extended from bottoms of the respective copper foils, and the first spool being sandwiched between each two the adjacent copper foils; a second iron core, a second projection being configured on one end face thereof, a second spool being put around the second projection, and the second projection being in combination with the axle body; and a solder bar, having a combination portion, a plurality of first through holes and a plurality of second through holes, the combination portion being in electric connection with a main board, the first connection portion and second connection portion being inserted in and bonded with the respective first through holes, and the third connection portion and fourth connection portion the respective second through holes.

Preferably, the first iron core and second iron core are respectively indented with a first accommodation space and second accommodation space, and the first projection and second projection are respectively accepted in the first accommodation space and second accommodation space.

Preferably, an outer diameter of each the first spool is larger than an inner diameter of each copper foil, allowing a predetermined spaced interval to exist between each two adjacent copper foils.

Preferably, a flange is configured on the axle body at a connection thereof with the first iron core and in combination with the first accommodation space of the first iron core, and two fixing elements are configured on a bottom of the flange.

Preferably, bottoms of the axle body and second spool are respectively configured with two first fixing elements and two second fixing elements.

Preferably, a length and width of said the iron core plus the second iron core respectively are 33 cm and 27.2 cm after being in combination with each other.

To improve transformers, the present invention adopts a transformer of size ATP33/27.2, changes copper lines used in conventional transformer into copper foils, improving the resistant capability to current effectively and further increasing the efficiency. The first and second spools 22, 33 respectively are a separable combination type; the benefit of such kind of design is in that they can be manufactured in advance in the shortest time and, only very little time is needed after the spools and copper foils are fixed such that the whole transformer is very advantageous in production cost and, production and assembly time can be reduced for power supply plants.

### BRIEF DESCRIPTION OF THE DRAWINGS

FIG. 1 is a perspective view of the present invention;

FIG. 2 is a perspective view of the present invention of FIG. 1 viewing from another angle;

FIG. 3 is a cross-sectional view of the present invention;

FIG. 4 is a perspective view of copper plates of another preferred embodiment according to the present invention; and

FIG. 5 is a circuit diagram of the present invention.

### DETAILED DESCRIPTION OF THE PREFERRED EMBODIMENTS

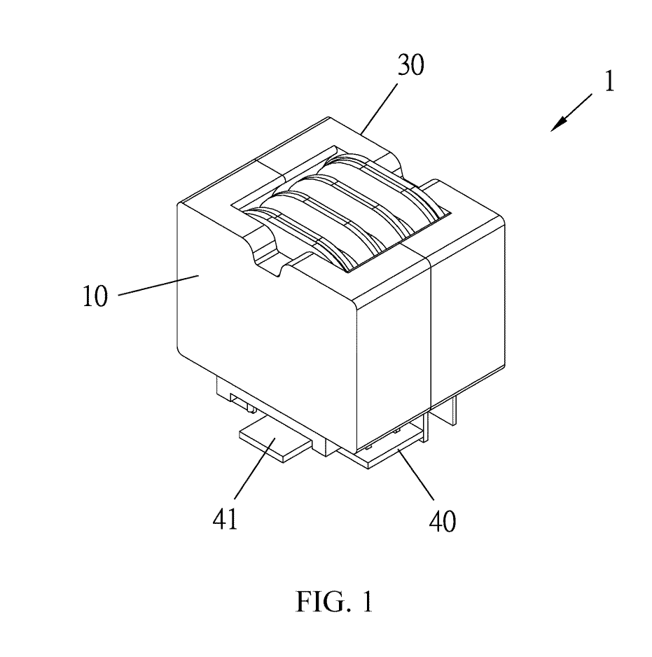

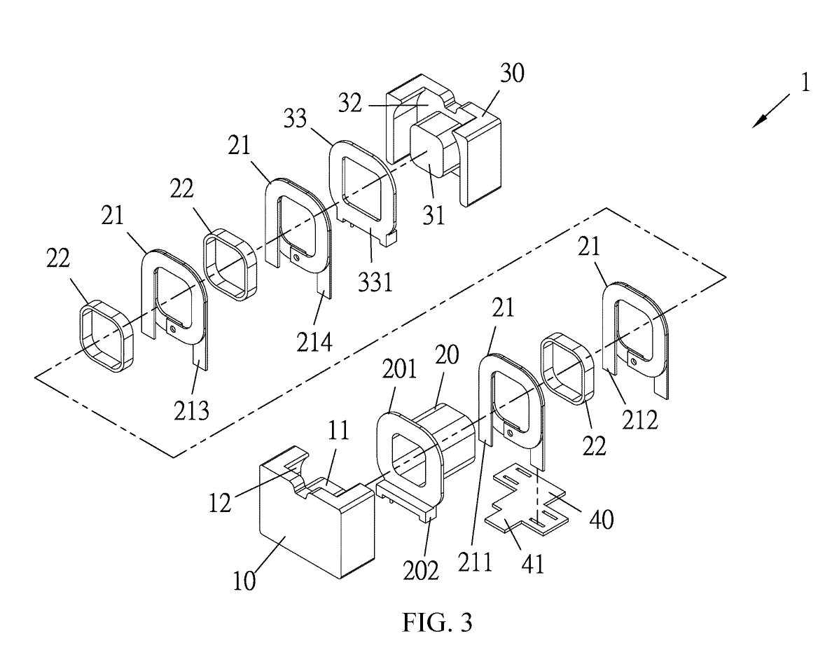

Referring to FIGS. 1 and 3, a server power transformer structure 1 according to the present invention includes a first iron core 10, axle body 20, second iron core 30 and a solder bar 40.

A first projection 11 is configured on one end face of the first iron core 10, and a first accommodation space 12 is further formed concavely on the first iron core 10, where the first projection 11 is positioned inside the first accommodation space 12.

The axle body 20 is a hollow body in combination with the first projection 11, and at least four copper foils 21 and a plurality of first spools 22 are configured on the axle body 20, where each copper foil 22 and each first spool 22 are respectively put around the axle body 20. Furthermore, the bottom faces of the copper foils 21 are respectively extended out with at least one first connection portion 211, at least one second connection portions 212, at least one third connection portion 213 and at least one fourth connection portion 214, and the first spool 22 is sandwiched between each two adjacent copper foils 22.

A flange 201 accepted in the first accommodation space 12 of the first iron core 10 is further configured on the axle body 20 at the connection thereof with the first iron core 10, and two first fixing elements 202 are further configured on the bottom of the flange 201.

A second projection 31 is configured on one end face of the second iron core 30, and a second accommodation space 32 is further formed concavely on the second iron core 32, where the second projection 31 is configured inside the second accommodation space 32.

A second spool 33 is put around the second projection 31 which is in connection with the axle body 20; after the first iron core 10 is in combination with the second iron core 30, the length and width of the combination thereof respectively are 33 cm and 27.2 cm, which are the best structural sizes.

In the embodiment, each copper foil 21 is a one-ring body suitable for full-bridge resonance designs; the design of the copper foil 21 can be applied in the condition of the power being larger than 1 kwatt, and may continue using the conventional first spool and second spool without changing the situation, the thickness of the copper foil 21 being possible to reach 1.2 mm. In contrast, a current copper foil used in a full-bridge structure generally is 1 mm in thickness. Therefore, the efficiency performance of the present invention is better than conventional designs.

Because the sizes of ATP cores available in the market are only to ATP27, it is definitely not enough if big power electric source (larger than 1 kwatt) want to be developed. Therefore, the size of ATP 33/27.2 of the present invention (power is larger than 1 kwatt) can solve the defects of the conventional transformers. The size specification of the present invention is derived from the designs of the internal space of a redundant power supply, and the height thereof cannot be beyond 34 mm. It can be clearly seen that the height of this core only is 33 mm such that it will not cause interference while being placed on a printed circuit board (PCB). In addition, it is unnecessary to excavate a PCB to lower the height of a transformer; the level of tolerance of a PCB will be damaged upon a vibration test and the wiring space thereof is reduced if the excavation thereof is carried out.

The sizes mentioned above can be used to design a transformer of the highest utilization rate (98%) inside an effective space. Here, the so-called “utilization rate” is a space can be used after the length is multiplied by the width, and this space is a space occupied by the first iron core 10, second iron core 30 and windable area (line winding area). The utilization rate of the transformer must be used to the highest in order to take into account a large enough cross-sectional area and the windable area; the cross-sectional area relates to the largest power value that can be obtained, and the windable the largest current than can be obtained.

Two second fixing elements 331 are further configured on the bottom of the second spool 33.

According to the present invention, the components may be manufactured in advance, and the first iron core 10, second iron core 30 and copper foils are then combined with the first spool 22 and second spool 33.

In addition, the distance between each two adjacent copper foils 21 can be kept because the first spool 22 and second spool 33 are adopted with a spool-style design, and the problem of defective products will not be made because the production errors caused from transformer manufacturers will not happen.

Because the axle body 20, first spool 22 and second spool 33 are separate, which is convenient for production and can reduce productive time compared with conventional transformers, which need line winding while assembly and fixtures for fixing copper foils, and are large in production error and high in finished product price.

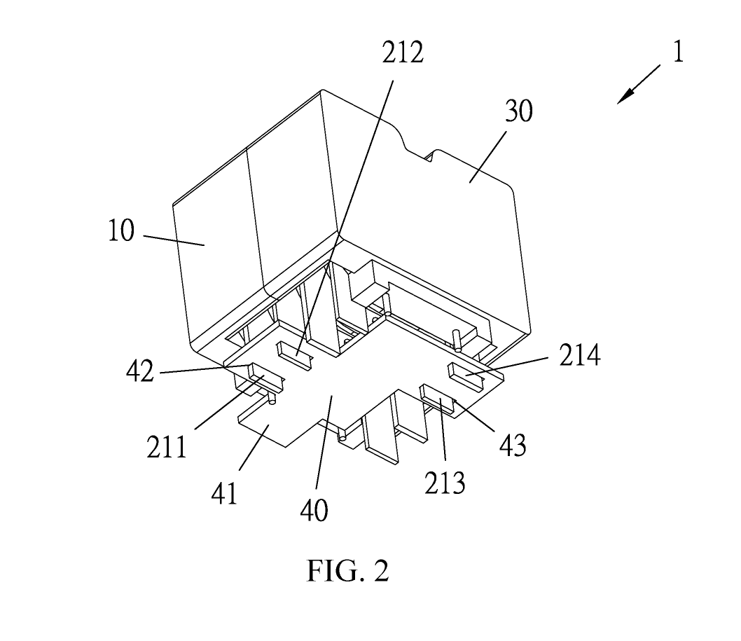

Referring to FIGS. 2 and 3, the solder bar 40 has a combination portion 41, a plurality of first through holes 42 and a plurality of second through holes 43, where the first connection portion 21 and second connection portion 212 are inserted in and bonded to the respective first through holes 42, and the third connection portion 213 and fourth connection portion 214 the respective second through holes 43.

The solder bar 40, which may also be called “current bus”, is designed to improve characteristics and efficiency; conventional designs all has a so-called center tap (output positive terminal) whether they are in half bridge or full bridge design; generally, the center tap is inserted in a main board after being in series with a printed circuit board (PCB) (four-layer plate), which cause a high cost resulting from the use of a PCB due to the intention to optimize resistance to current. The solder bar 40 of the present invention is lower in cost, larger resistance to current and higher in efficiency compared with the “PCB” way mentioned above. In addition, the solder bar 40 can be made in advance in a transformer plant, but the components of the PCB way must be finished in a power supply plant, increasing productive time and cost. After estimation, the present invention increases efficiency and reduces the production cost; although the cost of the transformer of the present invention may be higher, the total cost of power materials is decrease. Therefore, the present invention is very advantageous if the reduction of the productive time is further taken into consideration.

The outer diameter of each first spool 22 is larger than the inner diameter of each copper foil 21, allowing a predetermined spaced interval kept between the two adjacent copper foils 21.

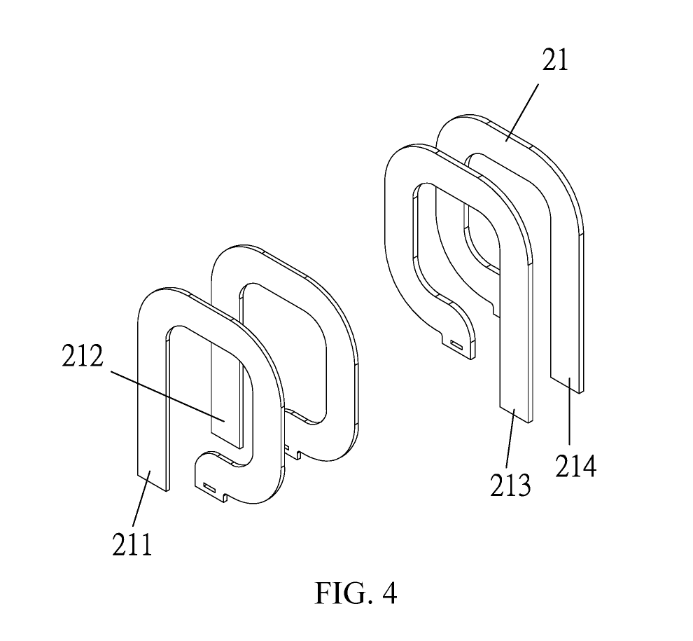

Referring to FIG. 4, the current highly-efficient transformers are all adopted with a half-bridge resonance design to achieve the efficiency improvement. In the embodiment, a ⅔ ring form is designed for the provision of half-bridge resonance by two rings of the copper foils 21 and, if three or four rings of the copper foils 21 are needed, only integrating them in series is enough. It is obvious that the present invention is very high in usability without needing other molds due to other requirements, and only one mold is all suitable.

Furthermore, when the copper foils 21 are in the ⅔ ring form, the bottoms thereof respectively have two first connection portions 211, two second connection portions 212, two third connection portions 213 and two fourth connection portions 214, one of each two connection portions being longer than the other, and the solder bar 40 offers the bonding with the long first connection portion 211, second connection portion 212, third connection portion 213 and fourth connection portion 214.

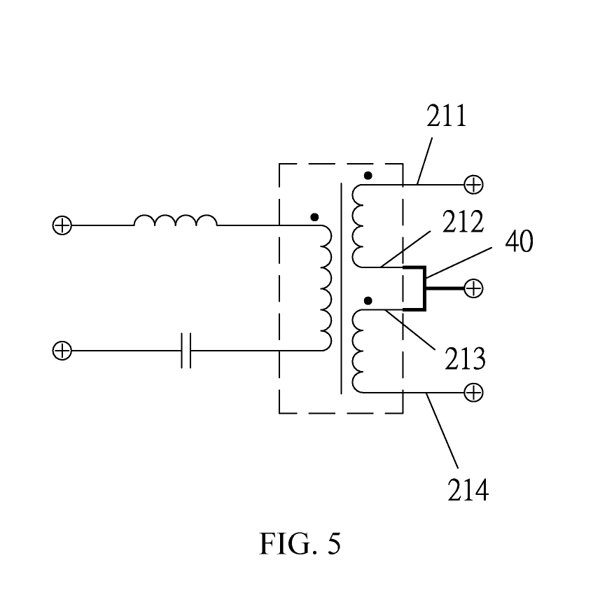

Referring to FIG. 5, whether the design is a half-bridge or full-bridge style, it is mainly characterized in that:
1. the solder bar 40 has a combination portion 41, a plurality of first through holes 42 and a plurality of second through holes 43, where the first connection portion 211 and second connection portion 212 are inserted in and bonded with the respective first through holes 42, and the third connection portion 213 and fourth connection portion 214 the respective second through holes; and
2. the solder bar offers the bonding with the longer first connection 211, second connection portion 212, third connection portion 213 and fourth connection portion 214.

A parallel circuit is formed among the copper foils 21 through the solder bar 40.

I claim:

1. A server power transformer structure, comprising:
a first iron core, a first projection being configured on one end face thereof;
an axle body, in combination with said first projection, and configured with at least four copper foils and a plurality of first spools thereon, each said copper foil and each said first spool being respectively put around said axle body, at least one first connection portion, at least one second connection portion, at least one third connection portion and at least one fourth connection portion being extended from bottoms of said respective copper foils, and said first spool being sandwiched between each two said adjacent copper foils;
a second iron core, a second projection being configured on one end face thereof, a second spool being put around said second projection, and said second projection being in combination with said axle body; and
a solder bar, having a combination portion, a plurality of first through holes and a plurality of second through holes, said combination portion being in electric connection with a main board, said first connection portion and second connection portion being inserted in and bonded with said respective first through holes, and said third connection portion and fourth connection portion said respective second through holes.

2. The structure according to claim 1, wherein said first iron core and second iron core are respectively indented with a first accommodation space and second accommodation space, and said first projection and second projection are respectively accepted in said first accommodation space and second accommodation space.

3. The structure according to claim 1, wherein an outer diameter of each said first spool is larger than an inner diameter of each said copper foil, allowing a predetermined spaced interval to exist between each two said adjacent copper foils.

4. The structure according to claim 1, wherein a flange is configured on said axle body at a connection thereof with said first iron core and in combination with said first accommodation space of said first iron core, and two fixing elements are configured on a bottom of said flange.

5. The structure according to claim 1, wherein bottoms of said axle body and second spool are respectively configured with two first fixing elements and two second fixing elements.

6. The structure according to claim 1, wherein a length and width of said first iron core plus said second iron core respectively are 33 cm and 27.2 cm after being in combination with each other.
